(19) United States
(12) Patent Application Publication
(10) Pub. No.: US 2005/0073161 A1
(43) Pub. Date: Apr. 7, 2005

(54) Collapsible grappling hook

(76) Inventor: Kevin Philbin, Glenview, IL (US)

Correspondence Address: Jeffrey R. Gargano;Wallenstein, Wagner & Rockey, Ltd., 53rd Floor, 311 South Wacker Drive, Chicago, IL, 60606-6622, US

(21) Appl. No.: 10/676,179

(22) Filed: Oct. 1, 2003

(51) Int. Cl. B66C 1/10

(52) U.S. Cl. 294/82.1

(57) ABSTRACT

A collapsible grappling hook (10) is disclosed comprising a shaft (12) having a longitudinal axis, a head (20), at least one arm (50), and a hub (70). The head (20) is operatively connected to a first end (14) of the shaft (20). The arm (50) is pivotally connected to the head (20) such that the arm (50) is moveable between a first closed position and a second open position. The hub (70) is rotatable about the axis of the shaft (12). The hub (70) has a locked position and an unlocked position. In the locked position, the hub (70) confronts the arm (50) to prevent pivoting of the arm between the open and closed positions. In the unlocked position, the arm (50) is pivotable between the open and closed positions.

### TECHNICAL FIELD

The present invention relates to grappling hooks. More specifically, the present invention relates to a grappling hook, which can be quickly moved between an operating position and a collapsed position.

### BACKGROUND OF THE INVENTION

Grappling hooks are well known devices, which are used for tethering or securing ropes, cables, and other devices to supporting structures. Grappling hooks are often used in climbing where a cable is secured to one end of the grappling hook. A myriad of uses of a grappling hook are well know in the art, including climbing, pulling, towing, securing, tying, connecting, and anchoring.

Traditional grappling hooks employ arms rigidly fixed to a shaft. These arms frequently have sharp teeth to assist in engaging the supporting structure. One disadvantage of these traditional grappling hooks is that they require significantly greater areas for storage. The collapsible grappling hook of the present invention requires only a fraction of the storage space required by traditional devices. Furthermore, the cumbersome nature of the traditional grappling hook makes transportation difficult and potentially unsafe. The extended and exposed arms and teeth of the traditional grappling hook are a safety hazard to those who may encounter the devices. In the collapsed position of the present grappling hook, the teeth on the inner edge of the arms are positioned between the arm and the shaft such that the risk of unintentional engagement of the teeth is greatly reduced.

Furthermore, the collapsible grappling hook of the present invention offers significant advantages over other folding grappling hooks. Some folding grappling hooks, such as those described in U.S. Pat. Nos. 6,079,761 and 6,062,621 collapse in a manner that the teeth of the arms remain facing at least partially outward where they might be inadvertently encountered by an individual thereby causing injury. As explained, the teeth on the arms of the present invention face radially inward towards the shaft virtually eliminating the risk of injury from the teeth. Other folding grappling hooks, such as the one disclosed in U.S. Pat. No. 6,267,424 utilize mechanisms which individually lock and unlock each arm of the grappling hook. This requires an operator significantly more time to unlock each arm sequentially, pivot the arm to the open position, and lock the arm in place. The problem of unnecessary time expenditure in preparing the grappling hook for operation is only exacerbated as the number of arms increases. A significant advantage of the collapsible grappling hook of the present invention is the speed and ease with which it may be operated between the collapsed and operational positions. The hub of the present invention offers a locking mechanism which quickly, easily, and simultaneously unlocks all of the arms of the grappling hook.

The collapsible grappling hook of the present invention is provided to solve these and other problems.

### SUMMARY OF THE INVENTION

A collapsible grappling hook is provided. The grappling hook comprises a shaft, a head, a hub, and a plurality of arms. The head is operatively connected to a first end of the shaft, while the second end of the shaft includes a connector, adapted to receive and be connected to a cable. The shaft includes a longitudinally extending axis. The head has a plurality of wings, each wing having a channel therein. The head further has a first pin and a second pin on each wing, the pins extending through the channel. The arms are pivotally connected to the head, in each of the channels. Specifically, each arm has a hole through which a respective first pin of the head passes, thereby pivotally connecting the arm to the head. Each arm also includes a curved slot in which the respective second pin slides. The second pin engages the curved slot in each arm to act as a stop to prevent over-rotation of the arm past the open position. The hub is rotatably mounted about the axis of shaft. Preferably, the hub is connected to the head of the grappling hook. The hub includes a plurality of radially extending members.

According to one aspect of the invention, the arms of the grappling hook pivot between a closed position wherein each arm is generally parallel to the axis of the shaft, and an open position wherein each arm is angulated with respect to the shaft.

According to another aspect of the invention, the hub is rotatable between a locked position and an unlocked position. In the locked position, the members of the hub are aligned with the wings of the head, and with the arms. In this position, the members of the hub confront a portion of each arm when the arm is pivoted between the closed and open positions. In this way, the hub acts as a locking mechanism to prevent pivoting of the arms. In the unlocked position, the hub is rotated such that the members and the arms are angulated about the axis of the shaft. In this position, the members no longer confront the arms. Thus, with the hub in the unlocked position, the arms are freely pivotable between the closed and open positions.

According to yet another aspect of the invention, the inner edge of each arm includes a plurality of teeth, which improve the engagement of the grappling hook to the supporting structure.

According to yet another aspect of the invention, the hub includes a plurality of grips, which facilitate grasping and actuation by an operator. The grips may protrude from or be recessed in the top surface of the hub.

According to yet another aspect of the invention, the hub and the head have cooperating structure to maintain the head in either the locked or unlocked positions. Specifically, the head includes a plurality of resilient tabs mounted in recesses in the head. The tabs are outwardly biased by springs located within the recess. The hub, in turn, includes a plurality of detents. The detents and tabs are aligned when the hub is connected to the head such that the tabs engage some of the detents. Rotation of the hub causes the tabs to disengage from the detents, and engage adjacent detents. In this manner, the interaction of the tabs and detents causes the hub to resist movement. Thus, these structures maintain the hub in a plurality of predetermined angular positions.

Other features and advantages of the invention will be apparent from the following specification taken in conjunction with the following drawings.

### BRIEF DESCRIPTION OF THE DRAWINGS

The present invention will now be described with reference to the accompanying drawings, in which:

FIG. 1 shows a perspective view of the grappling hook of the present invention in operation with a support structure;

FIG. 2 shows a perspective view of the grappling hook in the operational position;

FIG. 3 shows a perspective view of the grappling hook with the hub in the unlocked position;

FIG. 4 shows a perspective view of the grappling hook with the arms in the closed position;

FIG. 5 shows a perspective view of the grappling hook in the collapsed position;

FIG. 6 shows an exploded perspective view the grappling hook of the present invention;

FIG. 7 shows a partial top view of the grappling hook;

FIG. 8 shows a bottom view of the hub of the grappling hook;

FIG. 9 shows a partial cross-sectioned view of the grappling hook of FIG. 7, taken along line 9-9.

### DETAILED DESCRIPTION OF THE INVENTION

While this invention is susceptible of embodiment in many different forms, there is shown in the drawings and will herein be described in detail preferred embodiments of the invention with the understanding that the present disclosure is to be considered as an exemplification of the principles of the invention and is not intended to limit the broad aspect of the invention to the embodiments illustrated.

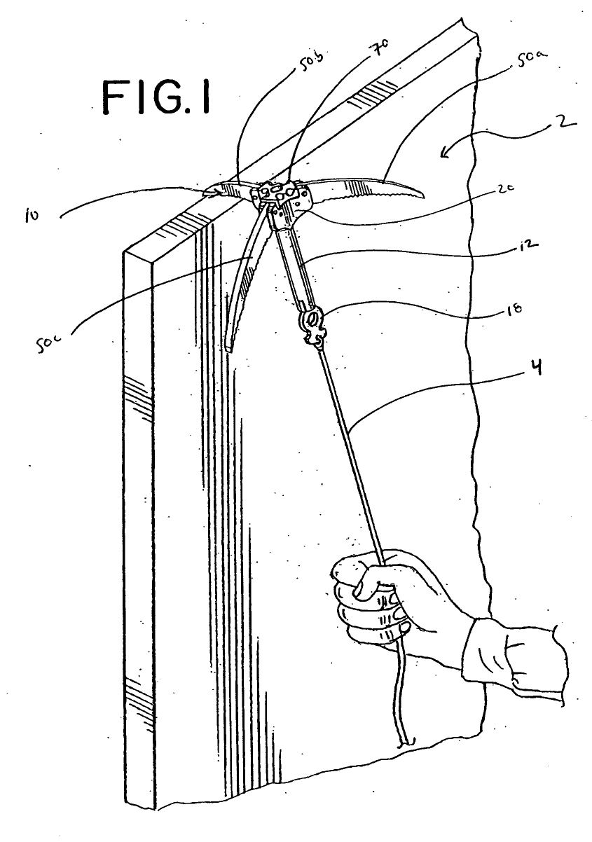

The grappling hook 10 of the present invention is depicted in FIG. 1 engaged to supporting structure 2. A cable 4 is connected to the grappling hook 10 to be used therewith. The cable 4 can be any of a variety of ropes, wires, strings, and cords well known in the art. The grappling hook 10 generally comprises a shaft 12, a head 20, a plurality of arms 50, and a hub 70.

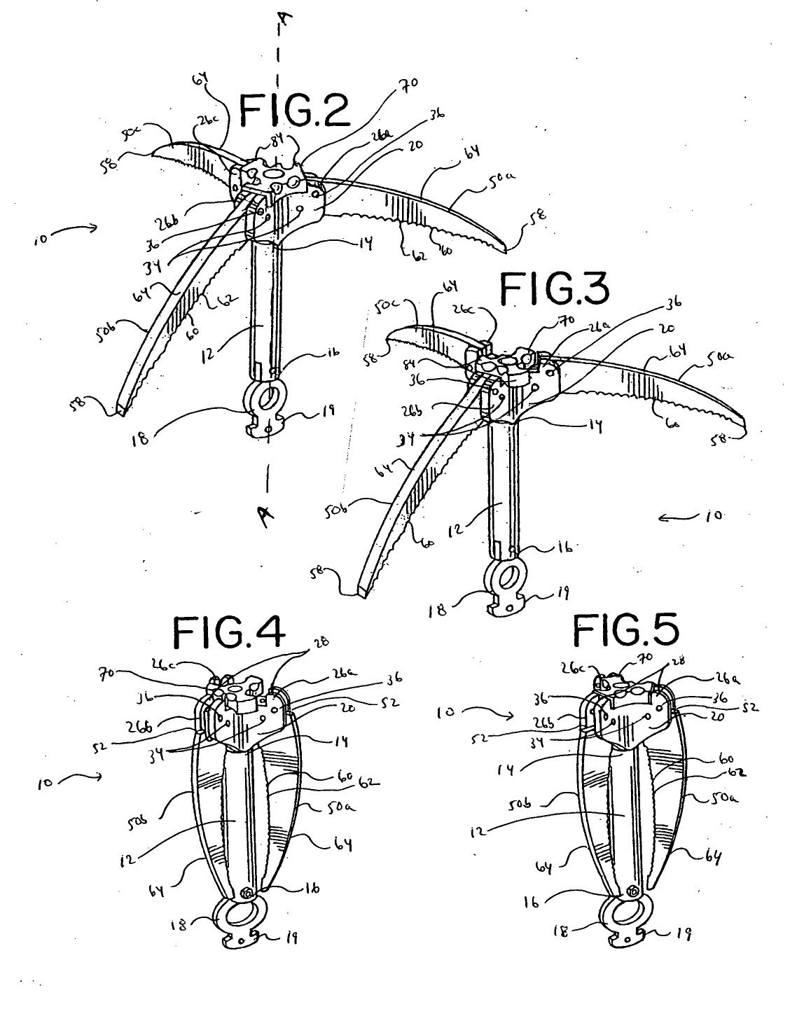

The shaft 12 of the grappling hook 10 is preferably an elongated cylinder having a longitudinal axis A-A, as seen in FIG. 2. The shaft 12 can be either solid or hollow along its length. The shaft 12 has a first end 14 and a second end 16. The second end 16 of the shaft 12 includes a connector 18 adapted to receive and be connected with the cable 4 with which the grappling hook is to be used. Preferably the connector 18 is a loop about which the cable 4 can be tied, however, a variety of connectors 18 for securing cable 4 well known in the art may be used. The connector 18 may include a cleat 19 projecting therefrom. The cleat 19 provides an additional element around which the cable 4 can be served. Preferably the cleat 19 is “T-shaped,” as seen in FIGS. 2-5, however, the cleat 19 can take on a variety of configurations.

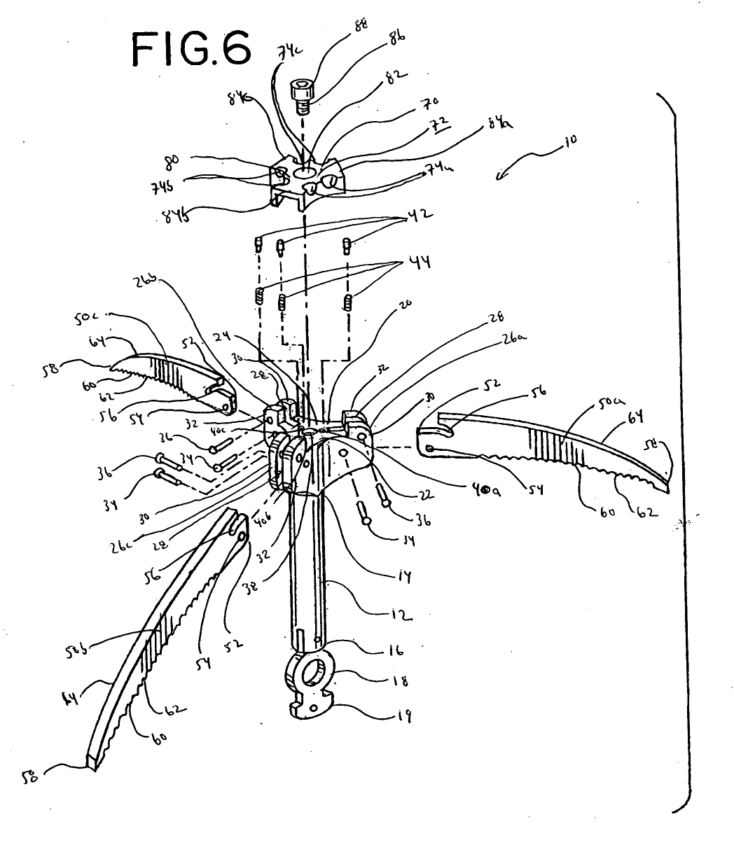

The head 20 of the grappling hook 10 is operatively connected to the first end 14 of the shaft 12, as seen in FIGS. 2 and 6. Preferably, the head 20 and shaft 12 are of one-piece construction, however, the head 20 and shaft 12 may be connected through a variety of methods including welding, soldering, threaded together, or fastened together with optional fasteners such as screws, bolts, or pins. The head 20 generally includes a base 22 having a top surface 24, and plurality of wings 26 extending radially from the base 22. Preferably, the head includes three wings 26a,26b,26c.

In the preferred embodiment, the base 22 has a generally cylindrical shape, as seen in FIG. 6. The top surface 24 of the base 22 includes an opening 38. The top surface 24 of the base 22 further includes a plurality of recesses 40 arranged circumferentially about the opening 38. Preferably, the top surface 24 has three equally circumferentially spaced recesses 40a,40b,40c. The recesses 40a,40b,40c are generally aligned with the wings 26a,26b,26c, as seen in FIG. 6. Positioned within each of the recesses 40a,40b,40c is a resilient tab 42a,42b,42c which is moveable into and out of the respective recess 40a,40b,40c. Each recess 40a,40b,40c further has a spring 44a,44b,44c located in between the resilient tab 42a,42b,42c and the recess 40a,40b,40c. The springs 44a,44b,44c bias the resilient tabs 42a,42b,42c out of the respective recess 40a,40b,40c, as seen in FIG. 9.

The wings 26a,26b,26c extend radially outwardly from the base 22, away from the longitudinal axis A-A of the shaft 12. Each wing 26a,26b,26c has a generally curvilinear configuration, however, the wings 26a,26b,26c can take on a variety of different configurations without departing from the spirit of the present invention. Each wing 26a,26b,26c includes a pair of sidewalls 30,32 and a channel 28 located in between the sidewalls 30,32. Each pair of sidewalls 30,32 and each channel 28 define a plane generally parallel to longitudinal axis A-A of the shaft 12. Each wing 26a,26b,26c further includes a pair of pins 34, 36 extending between the sidewalls 30,32 of the wing 26a,26b,26c. The first pin 34 is located on the wing 26a,26b,26c proximate the base 22, while the second pin 36 is located on the wing 26a,26b,26c away from the base. Stated differently, the first pin 34 is located radially intermediate the second pin 36 and the base 22. Both the first pin 34 and the second pin 36 are connected to each sidewall 30,32, and extend across the channel 28 in each wing 26a, 26b, 26c.

The grappling hook 10 further comprises a plurality of arms 50 pivotally mounted to the head 20. Preferably, the grappling hook 10 comprises three arms 50a, 50b, 50c, with one arm 50a, 50b, 50c mounted within each of the channels 28 of the wings 26a, 26b, 26c, as seen in FIGS. 2-5. Each arm 50a, 50b, 50c has a first end 52, a second end 58, an inner edge 60 and an outer edge 64. The first ends 52 of the arms 50a, 50b, 50c include a hole 54 and a curved slot 56. The hole 54 in each arm 50a, 50b, 50c is cooperatively dimensioned with the first pin 34 of each wing 26a, 26b, 26c. The curved slot 56 of each arm 50a, 50b, 50c is cooperatively dimensioned with the second pin 36 of each wing 26a, 26b, 26c. The first pins 34 pass through the holes 54 in the arms 50a, 50b, 50c to pivotally connect the arms 50a, 50b, 50c to the wings 26a, 26b, 26c of the head 20. More specifically, the first end 52 of each arm 50a, 50b, 50c is positioned within one of the respective channels 28 of the wings 26a, 26b, 26c. The first end 52 of each arm 50a, 50b, 50c may include an optional catch 53 extending therefrom. The inner edge 60 of the arm 50a, 50b, 50c faces generally toward the shaft 12 while the outer edge 64 of the arm 50a, 50b, 50c faces generally away from the shaft 12, as seen in FIGS. 4 and 5. The inner edge 60 includes at least one, and preferably a plurality of teeth 62 arranged along the length of the inner edge 60 of the arm 50a, 50b, 50c. The teeth 62 assist the engagement of the grappling hook 10 with the supporting structure 2.

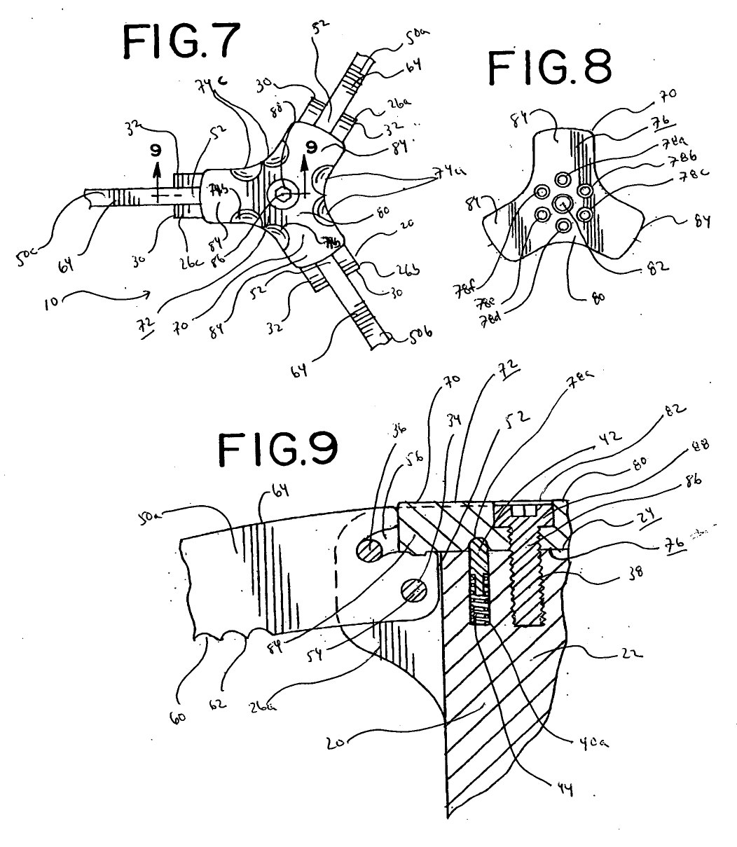

Finally, the grappling hook 10 comprises a hub 70 rotatable about the longitudinal axis A-A of the shaft 12, shown in FIGS. 6-8. Preferably, the hub 70 is rotatably mounted on the base 22 of the head 20. The hub 70 comprises a body 80, a plurality of members 84, a top surface 72, a bottom surface 76, and an axle 86. In a preferred embodiment, the hub 70 includes three members 84a,84b,84c extending radially outward from the body 80 of the hub 70, in a direction away from the longitudinal axis A-A of the shaft 12. The base 80 of the hub 70 includes an aperture 82 passing through the hub 70. The axle 86 is positioned within the aperture 82 to rotatably secure the hub 70 to the head 20. The axle 86 includes an enlarged cap 88, which maintains the connection between the hub 70 and the axle 86. The top surface 72 of the hub 70 include a plurality of grips 74 adapted to be engaged by an operator's fingers. Preferably, the top surface 72 includes three grips 74a,74b,74c, with one grip 74a,74b,74c positioned on at least a portion of a respective member 84a,84b,84c. The grips 74a,74b,74c are preferably recesses which can be accessed and manipulated by the operator's fingers. However, a variety of different grips 74a,74b,74c can be used without departing from the spirit of the present invention. For example, the grips 74a,74b,74c may be raised protrusions above the top surface 72 of the hub 70. Alternatively, the grips 74a,74b,74c may be a plurality of textured protrusions or ridges with which the operator's fingers can engage. As seem in FIG. 8, the bottom surface 76 of the hub 70 includes a plurality of detents 78 arranged circumferentially about the aperture 82 in the hub 70. In a preferred embodiment, the bottom surface 76 of the hub 70 has six detents 78a,78b,78c,78d,78e,78f. The detents 78a,78b,78c,78d,78e,78f are cooperatively dimensioned with the resilient tabs 42a,42b,42c of the head 20.

The following description is directed to the assembly of the grappling hook 10. As explained, the head 20 is rigidly fixed and connected to the first end 14 of the shaft 12. Each of the arms 50a,50b,50c is pivotally connected to the head 20. Specifically, the first pin 34 of each wing 26a,26b,26c passes through the hole 54 in the first end 52 of a respective arm 50a,50b,50c. Thus each arm 50a,50b,50c pivots about the first pin 34 to which it is connected. The second pin 36 of each wing 26a,26b,26c slides along the curved slot 56 in the respective arm 50a,50b,50c. Thus, pivoting of the arm 50a,50b,50c with respect to the head 20 causes the second pin 36 of each wing 26a,26b,26c to traverse the curved slot 56 in the respective arm 50a,50b,50c. Furthermore, each arm 50a,50b,50c is partially positioned in the channel 28 of a respective wing 26a,26b,26c, as seen in FIG. 6. Thus, the first end 52 of each arm 50a,50b,50c is positioned generally between the sidewalls 30,32 of each wing 26a,26b,26c. Pivoting of the arm 50a,50b,50c causes the first end 52 of each arm 50a,50b,50c to move within the respective channel 28 of the wing 26a,26b,26c.

The hub 70 is connected to the head 20 of the grappling hook 10 such that the hub 70 is free to rotate about the longitudinal axis A-A of the shaft 12. Specifically, the axle 86 is passed through the aperture 82 of the hub 70 and into the opening 38 in the base 22 of the head 20. The mating of the axle 86 and the opening 38 maintains the hub 70 in connection with the head 20. Preferably, the axle 86 and opening 38 are threaded, however, a variety of connection types may be used including a friction fit, an arrangement of splines, or the use of fasteners. The enlarged cap 88 of the axle 86 seats in the bottom of the aperture 82 of the hub 70 to prevent the hub 70 from disengaging the head 20. As the hub 70 is seated on top of the head 20, the tabs 42a,42b,42c engage three of the six detents 78a,78b,78c, as seen in the FIGURES. The engagement of the tabs 42a,42b,42c with the detents 78a,78b,78c does not prevent rotation of the hub 70, but resists the rotation of the hub 70 about the axis A-A. When the hub 70 is rotated about the axis A-A, the tabs 42a,42b,42c disengage the detents 78a,78b,78c and are compressed into the recesses 40a,40b,40c in the head 20, against the forces of the springs 44a,44b,44c. Continued rotation of the hub 70 will cause the adjacent detents 78d,78e,78f to come into alignment with the resilient tabs 42a,42b,42c at which time the tabs 42a,42b,42c will resiliently snap back out of the recesses 40a,40b,40c and into engagement with the adjacent detents 78d,78e,78f. Further rotation of the hub 70 about the axis A-A results in the tabs 42a,42b,42c alternatively disengaging one set of detents 78d,78e,78f and engaging the adjacent set of detents 78a,78b,78c. Thus, the cooperation of the tabs 42a,42b,42c and the detents 78a,78b,78c,78d,78e,78f causes the hub 70 to resist rotation about the axis A-A. This causes the hub 70 to “click” into certain predetermined angular positions about the axis A-A, based upon the arrangement of the tabs 42a,42b,42c and the detents 78a,78b,78c,78d,78e,78f.

The following description is directed at the operation of the grappling hook 10. Once assembled, the grappling hook 10 operates by collapsing and expanding the arms 50a,50b,50c between a closed position and an open position, via movement of the hub 70 and the arms 50a,50b,50c. FIG. 5 depicts the grappling hook 10 in the collapsed position. As can be seen, the arms 50a,50b,50c are folded inward adjacent to the shaft 12, such that the arms 50a,50b,50c are generally parallel to the longitudinal axis A-A of the shaft 12. In this position, the arms 50a,50b,50c are in the first or closed position. The catch 53 located at the first end 52 of each arm 50a,50b,50c, contacts the respective second pin 36 which prevents the second end 58 of each arm 50a,50b,50c from contacting or striking the shaft 12. At the same time, as seen in FIG. 5, the hub 70 is positioned such that the members 84a,84b,84c are aligned with the both the wings 26a,26b,26c and the arms 50a,50b,50c. In this position, the hub 70 is in the locked position. When in the locked position, the members 84a,84b,84c are positioned so that they at least partially cover the channels 28 of the wings 26a,26b,26c. Stated differently, the members 84a,84b,84c partially cover the first ends 52 of the arms 50a,50b,50c such that the bottom surface 76 of the hub 70, specifically the members 84a,84b,84c, confront the arms 50a,50b,50c to prevent pivoting of the arms 50a,50b,50c.

A significant advantage of the collapsible grappling hook 10 over a traditional device is the compact nature of the grappling hook 10 in the collapsed position, as seen in FIG. 5, which is a significant improvement for storing and transporting the device. Traditional grappling hooks employing rigidly fixed arms require significantly greater areas for storage. In the collapsed position, the grappling hook 10 of the present invention requires only a fraction of the storage space required by traditional devices. Furthermore, the cumbersome nature of the traditional grappling hook makes transportation difficult and potentially unsafe. The extended and exposed arms and teeth of the traditional grappling hook are a safety hazard to those who may encounter the devices. In the collapsed position of the present grappling hook 10, the teeth 62 on the inner edge 60 of the arms 50a,50b,50c are positioned between the arm 50a,50b,50c and the shaft 12 such that the risk of unintentional engagement of the teeth 62 is greatly reduced.

FIG. 4 shows the hub 70 in the unlocked position. The hub 70 is moved from the locked position to the unlocked position by rotation of the hub 70 about the axis A-A of the shaft 12. As the hub 70 is rotated, it comes to rest in the unlocked position due to the interaction of the resilient tabs 42a,42b,42c and detents 78a,78b,78c,78d,78e,78f as described previously herein. Thus, the hub 70 “clicks” into place in the unlocked position as it is manually rotated out of the locked position. It does not matter in which direction the hub 70 is rotated. In the unlocked position, the members 84a,84b,84c are positioned in between the arms 50a,50b,50c. Stated differently, the members 84a,84b,84c and the arms 50a,50b,50c are angulated about the axis A-A of the shaft. In this unlocked position, the arms 50a,50b,50c are freely pivotable about their respective first pins 34, as the members 84a,84b,84c are moved out of confrontation with the arms 50a,50b,50c.

With the hub 70 in the unlocked position, the arms 50a,50b,50c may be pivoted to their second or open position, shown in FIG. 3. As each arm 50a,50b,50c is moved from the closed position to the open position, the arm 50a,50b,50c pivots about the first pin 34 of the respective wing 26a,26b,26c. Simultaneously, the second pin 36 of the respective wing 26a,26b,26c slides along and traverses the curved slot 56 in the arm 50a,50b,50c. The arm 50a,50b,50c continues to pivot until the second pin 36 reaches the end of the curved slot 56. When the second pin 36 traverses the entire length of the curved slot 56, it engages arm 50a,50b,50c at the end of the curved slot 56. In this position, the arm 50a,50b,50c is in the open position, as seen in FIG. 3. In this way, the second pin 36 acts as a stop to prevent over-rotation of the arm 50a,50b,50c past the open position when the arm 50a,50b,50c is moved from the closed to the open positions. It will be understood by those skilled in the art that a variety of different stops can be utilized in place of the second pin 36. The stop could also be located on a variety of different locations on the head 20. Preferably, the stops are located in the channels 28 of each wing 26a,26b,26c. All that is important is that the stop be located to confront the arm 50a,50b,50c and prevent further pivoting past the open position.

Once the arms 50a,50b,50c are in the open position, the hub 70 is returned to the locked position, as shown in FIG. 2. The hub 70 is rotated about the longitudinal axis A-A of the shaft such that the members 84a,84b,84c again become aligned with both the wings 26a,26b,26c and the arms 50a,50b,50c. As before, rotation of the hub 70 in either direction from the unlocked position will return the hub 70 to the locked position, as seen in FIG. 2. The hub 70 will “click” into place when the hub 70 reaches the locked position due to the interaction of the resilient tabs 42a,42b,42c and the detents 78a,78b,78c,78d,78e,78f, as described previously herein.

With the hub 70 in the locked position and the arms 50a,50b,50c in the open position, as seen in FIG. 2, the grappling hook 10 of the present invention is in the operational position and is usable to engage and be secured to supporting structure 2, as seen in FIG. 1. The cord 4 with which the grappling hook 10 is to be used is first secured to the connector 18 at the second end 16 of the shaft 12. Then, the grappling hook 10 is used in the traditional fashion. By way of example, the grappling hook 10 may be used to engage a supporting structure 2 such as a wall, as seen in FIG. 1, such that the operator may then use the attached cord 4 as an instrument for climbing. The myriad of uses of a grappling hook 10 are well know in the art, including climbing, pulling, towing, securing, tying, connecting, and anchoring.

Following use of the grappling hook 10, the grappling hook 10 of the present invention may be collapsed for purposes of convenience during storage and transportation. This process is the reverse of the procedure explained above for placing the grappling hook 10 in the operational position. Specifically, to collapse the grappling hook 10, the hub 70 is first moved from the locked position seen in FIG. 2 to the unlocked position seen in FIG. 3 to permit pivoting of the arms 50a,50b,50c with respect to the head 20. Once the hub 70 is in the unlocked position, the arms 50a,50b,50c are pivoted from the open position to the closed position, as seen in FIG. 4. When the arms 50a,50b,50c are returned to the closed position generally parallel to the shaft 12, the hub 70 is rotated to the locked position as seen in FIG. 5. With the hub 70 in the locked position and the arms 50a,50b,50c in the closed position, the grappling hook 10 is in the collapsed position, as seen in FIG. 5. The locked hub 70 prevents the arms 50a,50b,50c from accidentally pivoting out of the closed position when the grappling hook 10 is not in use. Thus, the grappling hook 10 remains secured in the collapsed position during storage and transportation.

While the specific embodiments and various details thereof have been illustrated and described, numerous modification come to mind without significantly departing from the spirit of the invention, and the scope of protection is only limited by the following claims.

1. A collapsible grappling hook comprising:
a shaft having a longitudinal axis;
a head operatively connected to a first end of the shaft;
at least one arm pivotally connected to the head such that the arm is moveable between a first closed position and a second open position; and
a hub rotatable about the axis, the hub having a locked position, wherein the hub confronts the arm to prevent pivoting of the arm between the open and closed positions, and an unlocked position, wherein the arm is pivotable between the open and closed positions.

2. The grappling hook of claim 1, wherein the head includes a pin and the arm includes an aperture, wherein the pin passes through the aperture to pivotally connect the arm to the head.

3. The grappling hook of claim 1, wherein a second end of the shaft is configured to be connected to a cable.

4. The grappling hook of claim 1, wherein the hub has a bottom surface, which confronts the arm when the hub is in locked position.

5. The grappling hook of claim 1, wherein the hub includes at least one grip adapted to be gripped by the fingers of an operator.

6. The grappling hook of claim 1, wherein the hub includes at least one member extending radially from the axis such that the member is aligned with the arm when the hub is in the locked position.

7. The grappling hook of claim 6, wherein the member and the arm are angulated about the axis when the hub is in the unlocked position.

8. The grappling hook of claim 1, wherein the arm is angulated with respect to the axis when the arm is in the open position.

9. The grappling hook of claim 1, wherein the arm is generally parallel to the axis when the arm is in the closed position.

10. A collapsible grappling hook comprising:
a shaft having a longitudinal axis;
a head operatively connected to a first end of the shaft, the head having at least one pin;
at least one arm pivotally connected to the pin such that the arm is moveable between a first closed position and a second open position; and
a hub rotatable about the axis, the hub having a locked position, wherein the hub confronts the arm to prevent pivoting of the arm between the open and closed positions, and an unlocked position, wherein the arm is pivotable between the open and closed positions.

11. The grappling hook of claim 10, further comprising a connector connected to a second end of the shaft, wherein the connector is configured to receive a cable.

12. The grappling hook of claim 11, wherein the connector includes a cleat.

13. The grappling hook of claim 10, wherein the head further comprises a second pin, wherein the arm includes a curved slot in which the second pin slides.

14. The grappling hook of claim 10, wherein the head further comprises at least one stop which confronts the arm to prevent the arm from pivoting past the open position when the arm is moved from the closed position to the open position.

15. The grappling hook of claim 10, wherein the hub and the head have cooperating structure to maintain the head in either the locked or unlocked position.

16. The grappling hook of claim 10, wherein the hub has one of at least one resilient tab and at least one detent and the head has the other of at least one resilient tab and at least one detent, wherein the tab engages the detent to maintain the head in a predetermined angular position.

17. The grappling hook of claim 16, wherein the hub comprises six detents and the head comprises three resilient tabs.

18. The grappling hook of claim 10, wherein the hub includes at least one member extending radially from the axis such that the member is aligned with the arm when the hub is in the locked position.

19. The grappling hook of claim 10 comprising three arms.

20. The grappling hook of claim 18 comprising three arms and three members.

21. The grappling hook of claim 10 wherein the arm includes at least one tooth.

22. A collapsible grappling hook comprising:
a shaft having a longitudinal axis;
a head operatively connected to a first end of the shaft, the head having a plurality of first pins;
a plurality of arms, each arm pivotally connected to one of the first pins such that the arm is moveable between a first closed position and a second open position; and
a hub rotatable about the axis, the hub having a plurality of members extending radially from the axis, the hub having a locked position, wherein the members are aligned with the arms and confront the arms to prevent pivoting of the arms between the open and closed positions, and an unlocked position, wherein the members and the arms are angulated about the axis such that the arms are pivotable between the open and closed positions.

23. The grappling hook of claim 22 comprising three arms.

24. The grappling hook of claim 22 comprising three members.

25. The grappling hook of claim 23 comprising three members.

26. The grappling hook of claim 22, wherein the arms are generally parallel to the axis when the arms are in the closed position.

27. The grappling hook of claim 22, wherein the arms are generally perpendicular to the axis when the arms are in the open position.

28. The grappling hook of claim 22, wherein the hub and the head have cooperating structure to maintain the head in either the locked or unlocked position.

29. The grappling hook of claim 22, wherein the hub has one of at least one resilient tab and at least one detent and the head has the other of at least one resilient tab and at least one detent, wherein the tab engages the detent to maintain the head in a predetermined angular position.

30. The grappling hook of claim 22, wherein the arm includes at least one tooth.

31. The grappling hook of claim 22, further comprising a connector connected to a second end of the shaft, wherein the connector is configured to receive a cable.

32. The grappling hook of claim 31, wherein the connector includes a cleat.

33. A method of opening and securing a collapsible grappling hook comprising the steps of:
providing a collapsible grappling hook comprising:
a shaft having a longitudinal axis;
a head operatively connected to a first end of the shaft;
at least one arm pivotally connected to the head such that the arm is moveable between a first closed position and a second open position; and
a hub rotatable about the axis, the hub having a locked position, wherein the hub confronts the arm to prevent pivoting of the arm between the open and closed positions, and an unlocked position, wherein the arm is pivotable between the open and closed positions;
moving the hub into the unlocked position;
pivoting the arm from the closed position to the open position; and
moving the hub into the locked position to secure the arm in the open position.

34. A method of closing and securing a collapsible grappling hook comprising the steps of:
providing a collapsible grappling hook comprising:
a shaft having a longitudinal axis;
a head operatively connected to a first end of the shaft;
at least one arm pivotally connected to the head such that the arm is moveable between a first closed position and a second open position; and
a hub rotatable about the axis, the hub having a locked position, wherein the hub confronts the arm to prevent pivoting of the arm between the open and closed positions, and an unlocked position, wherein the arm is pivotable between the open and closed positions;
moving the hub into the unlocked position;
pivoting the arm from the open position to the closed position; and
moving the hub into the locked position to secure the arm in the closed position.
